(19) United States
(12) Patent Application Publication
(10) Pub. No.: US 2008/0098765 A1
(43) Pub. Date: May 1, 2008

(54) Device for making slush drinks

(75) Inventor: Gregg Alan Bond, Beverly Hills, CA (US)

Correspondence Address: YING CHEN;Chen Yoshimura LLP, 255 S. GRAND AVE., # 215, LOS ANGELES, CA, 90012, US

(73) Assignee: The Helman Group, Ltd.

(21) Appl. No.: 11/588,754

(22) Filed: Oct. 27, 2006

(51) Int. Cl. A23G 9/00; F25C 1/00

(52) U.S. Cl. 62/342; 62/353

(57) ABSTRACT

A slush drink maker for household use is described. It includes a base housing a motor, a mixing chamber removably mounted on the base, an ice canister and auger assembly disposed substantially horizontally inside the mixing chamber, and a cover for covering the mixing chamber. The ice canister and auger assembly include a cylindrical ice canister, an auger disposed around the ice canister, and a gearbox which drives the auger to rotate in a first direction and drive the ice canister to rotate in a second direction opposite the first direction. The ice canister has a divider that divides an interior space of the ice canister into two or more compartments parallel to a rotation axis of the ice canister. In addition, the auger and the front end of the mixing chamber have improved shapes which facilitate the dispensing of the content from the mixing chamber.

### BACKGROUND OF THE INVENTION

This invention relates to a device for making a slush drink, and in particular, it relates to such a device for household use.

### SUMMARY OF THE INVENTION

An object of the present invention is to provide an improved slush drink maker that is suitable for household use and is easy to operate and easy to clean.

Another object of the present invention is to provide an improved slush drink maker that has an increased cooling efficiency.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a device for making slush drinks, which includes: a base housing a motor; a mixing chamber removably mounted on the base; an ice canister and auger assembly disposed substantially horizontally inside the mixing chamber, the ice canister and auger assembly including a cylindrical ice canister, an auger disposed around the ice canister, and a gearbox engaged with the auger and the ice canister; and a cover for covering the mixing chamber. The base further includes a drive shaft driven by the motor, and the gearbox of the ice canister and auger assembly is engaged with the drive shaft to drive the auger to rotate in a first direction and to drive the ice canister to rotate in a second direction opposite the first direction. The ice canister has a divider that divides an interior space of the ice canister into two or more compartments parallel to a rotation axis of the ice canister.

In addition, the auger includes a plurality of blades located at its front end, the blades forming an angle of approximately 15 to 25 degrees (preferably approximately 20 degrees) with respect to a plane perpendicular to a rotation axis of the auger. The mixing chamber has a front end wall and a dispenser located on the front end wall, the front end wall being substantially vertical with a pie-shaped portion adjacent the dispenser that forms a wedge angle in the range of approximately 6 to 10 degrees (preferably approximately 8 degrees) with respect to the vertical direction.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a perspective view of a slush drink maker according to an embodiment of the present invention.

FIG. 2 is a perspective view of the slush drink maker of FIG. 1 with the cover removed.

FIG. 3 is am exploded view of the slush drink maker of FIG. 1.

FIGS. 4(a)-4(d) show parts of the ice canister and auger assembly of the slush drink maker of FIG. 1.

FIG. 5 illustrates a divider for the ice canister.

### DETAILED DESCRIPTION OF THE PREFERRED EMBODIMENTS

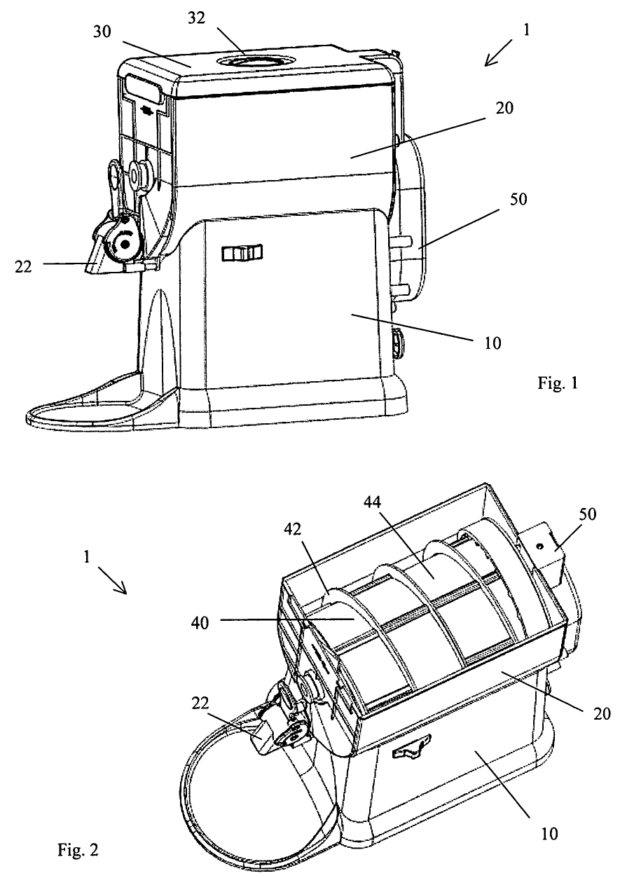

As shown in FIGS. 1-3, a slush drink maker 1 according to an embodiment of the present invention includes a base 10, a mixing chamber 20 mounted on the base, an ice canister and auger assembly 40 disposed inside the mixing chamber, and a cover 30 for covering the mixing chamber. The mixing chamber 20 is preferably made or a food grade material such as plastic, stainless steel or aluminum; a clear plastic material is more preferred so the contents of the mixing chamber is visible. A dispenser 22 is provided at the front end of the mixing chamber 20 to dispense the content from the mixing chamber. The cover 30 preferably has an opening 32 for loading ingredients into the mixing chamber during operation, and a lid 34 for closing the opening.

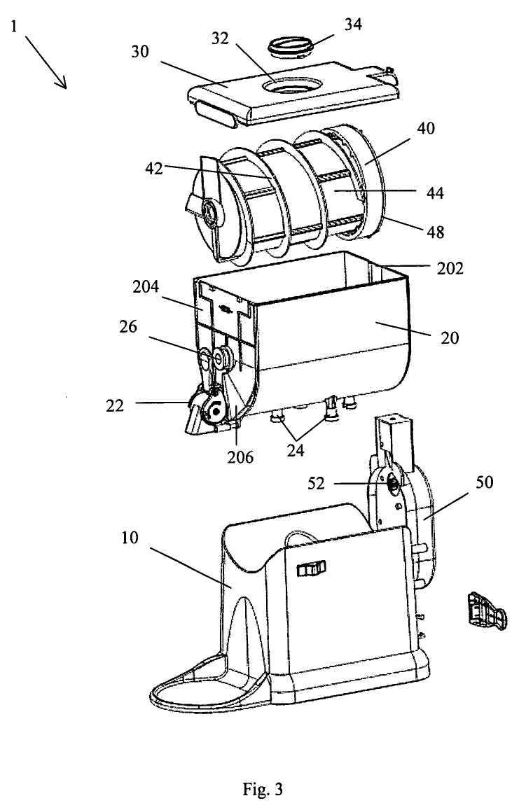

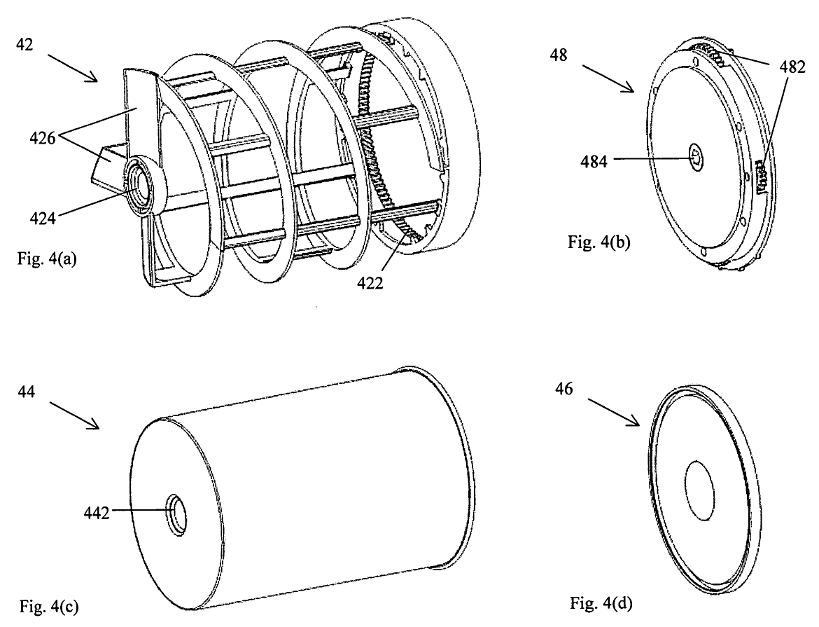

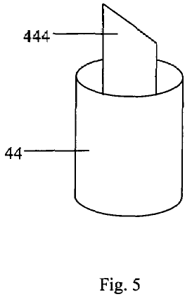

The ice canister and auger assembly 40 includes a cylindrical shaped ice canister 44 and an auger 42 disposed around the ice canister. FIGS. 4(a)-4(d) illustrates various parts of the ice canister and auger assembly 40. The ice canister 44 is preferably made of a material that has a high thermal conductivity and acts as a good heat sink, such as metal. More preferably, the ice canister 44 is made of aluminum. One end of the ice canister 44 is open for loading ice, and a lid 46 (FIG. 4(d)) is provided to close the ice canister. In the assembled state, the ice canister 44 (with the lid 46 on) is disposed in an interior space formed by the auger (see FIG. 3). As shown in FIG. 4(b), the ice canister and auger assembly 40 further includes a gearbox 48 to which the auger 42 and ice canister 44 are engaged. The gearbox 48 has a generally disc-like shape and has one or more gears 482 on its rim, which engage with a gear 422 on an inside surface near the back end of the auger 42 (FIG. 4(a)) when the ice canister and auger assembly is in the assembled state. The gearbox 48 has a socket 484 at the center for engaging a drive shaft 52 of a second gearbox 50 (described later). The drive shaft 52 drives the gears 482 to cause the auger 42 to rotate in a first direction so that the spiral of the auger 42 pushes the content toward the front end of the device where the dispenser 22 is located. The ice canister 44 is engaged with the gearbox 48 via a nut on the lid 46 (located on the side opposite the side shown in FIG. 4(d)) and is driven to rotate in a second direction opposite to the first direction. Although an example of the gearbox 48 is shown in FIG. 4(b), those skilled in the mechanical art will recognize that the gearbox 48, the corresponding gears of the auger 42, and the nut on the ice canister lid 46 may have various alternative designs so long as the gearbox 48 drives the auger and the ice canister to rotate in opposite directions at appropriate speeds.

In the assembled state, the ice canister and auger assembly 40 is disposed substantially horizontally inside the mixing chamber 20. The mixing chamber has a vertical slot 202 on its back end wall, and the gearbox 48 has one or more raised ribs on its backside (opposite to the side shown in FIG. 4(b)) that fit into the slot to lock the ice canister and auger assembly 40. In addition, the bottom of ice canister 44, which is located near the front end of the mixing chamber 20 when assembled, has an indentation 442, and the front end of the auger 42 has a hole 424 corresponding to the indentation 442. The mixing chamber 20 also has a hole on its front end wall corresponding to the location of the hole 424 when the ice canister and auger assembly 40 is disposed in the mixing chamber. In the assembled state, a knob 26 (see FIG. 3) is inserted through the holes of the mixing chamber 20 and the auger 42 into the indentation 442 of the ice canister 44 to lock the ice canister and auger assembly 40 in place. Similarly, the back end wall of the mixing chamber 20 also has a hole corresponding to the location of the socket 484, and another knob (not shown) may be provided to lock the back end of the ice canister and auger assembly 40 to the mixing chamber 20. Those skilled in the mechanical art will recognize that other structures for locking the ice canister and auger assembly to the mixing chamber may be used.

The second gearbox 50 is permanently attached to the base 10 (and can be considered a part of the base 10). A motor (not shown) is housed in the base 10 or gearbox 50, and drives the drive shaft 52 via a suitable set of gears.

The mixing chamber 20 is locked to the base 10 by a plurality of posts 24 on the bottom of the mixing chamber 20. The base 10 has a plurality of corresponding receiving holes for receiving the posts, and each hole has a narrower slit extending from the hole toward the back end of the device. When mounting the mixing chamber 20, the posts 24 are inserted into the holes on the base, and the mixing chamber is pushed toward the back end so the posts slide into the slits. This also causes the socket 484 of the gearbox 48 to engage the drive shaft 52 of the second gearbox 50. Each post 24 has a foot to prevent it from being pulled out from the slits, thereby locking the mixing chamber 20 to the base 10. Other suitable structures for mounting the mixing chamber 20 to the base 10 may be employed.

A number of locks (not shown) are provided to lock the mixing chamber 20 to the gearbox 50 so that when the ice canister and auger assembly 40 is driven by the gearbox 50, the mixing chamber is prevented from being pushed away from the gearbox 50. Any suitable locks may be used. For example, they may be locks formed by hooks and wires, or locks formed of a post on the gearbox 50 inserted into the mixing chamber 20 or vice versa.

The cover 30 is provided with a suitable lock to lock it to the mixing chamber 20 as well as the top of the gearbox 50. The mixing chamber 20, the ice canister and auger assembly 40 (including its various components) and the cover 30 can be separated from the base 10 and from each other for easy cleaning.

To improve the effectiveness of the slush drink maker, a removable dividing plate 444 is insert in the ice canister 44, as shown in FIG. 5. The dividing plate 444 has a width substantially the same as the inner diameter of the ice canister 44, and a length substantially the same as the length of the canister to divide the space inside the canister into two halves. Ice is loaded into both halves of the ice canister 44. When making a slush drink, the ice in the ice canister gradually melts. If the dividing plate 444 is not present, water will collect at the bottom of the ice canister and reduces the ability of the ice canister to uniformly cool the content of the mixing chamber. When the dividing plate 444 is provided, each half of the canister will contain both water and ice as the ice melts, and because each half is alternately raised and lowered as the ice canister rotates, less water will accumulate at the bottom of the canister, whereby increasing the uniformity of cooling. Alternatively, instead of a simple plate, a divider such as a Y-shaped divider, an X-shaped divider, etc. may be provided that divides the ice canister into three or more compartments parallel to its rotation axis.

The auger 42 and the front end wall of the mixing chamber 20 have improved shapes which facilitate the dispensing of the content from the mixing chamber. The auger 42 has a plurality of blades 426 at the front end located in close proximity of the front end wall 204 of the mixing chamber 20. The blades 426 form an angle of approximately 15 to 25 degrees (preferably approximately 20 degrees) with respect to a plane perpendicular to the rotation axis of the auger. The front end wall 204 of the mixing chamber 20 is generally vertical (perpendicular to the rotation axis of the auger), but has a pie-shaped portion 206 adjacent the dispenser 22 that bends outwardly and forms a wedge angle in the range of approximately 6 to 10 degrees (preferably approximately 8 degrees) with respect to the vertical direction. The blades 426 and the pie-shaped portion 206 cooperate to create a pushing force in the horizontal direction when the auger rotates, which helps to sweep and push the slush out of the mixing chamber through the dispenser when it is open.

The operation of the slush drink maker 1 is described below. First, the ice canister 44 is filled with ice. An appropriate amount of salt is added to the ice, and a small amount of lukewarm water is added to the ice and salt mixture. The ice canister 44 is shaken briefly with the lid 46 closed, and then placed inside the auger 42. The gearbox 48 is placed over the auger so that the gears 482 of the gearbox 48 and gears 422 of the auger engage each other. The ice canister and auger assembly 40 is placed into the mixing chamber 20 by sliding the raised ribs on the gearbox 48 into the vertical slot 202 of the mixing chamber 20. When the ice canister and auger assembly 40 is slightly lifted and rotated, the knob 26 at the front end and the knob at the back end are pushed in to lock the ice canister and auger assembly 40 in the mixing chamber 20. The mixing chamber 20 is placed on the base 10 (the posts 24 being inserted into the corresponding holes on the base), and slowly pushed backwards toward the gearbox 50 until the socket 484 of the ice canister and auger assembly 40 is engaged with the drive shaft 52 of the gearbox 50. Ingredients (such as soda, juice or the like) are poured into the mixing chamber, and the cover 30 is place over the chamber and locked in place. The motor is then turned on to rotate the auger 42 and the ice canister 44. When the motor is running, additional ingredients may be added via the opening 32 of the cover 30. The ingredients gradually cool and freeze into a flavored slush. The slush can be dispensed from the dispenser 22.

It will be apparent to those skilled in the art that various modification and variations can be made in the slush drink maker of the present invention without departing from the spirit or scope of the invention. Thus, it is intended that the present invention cover modifications and variations that come within the scope of the appended claims and their equivalents.

What is claimed is:

1. A device for making slush drinks, comprising:
a base housing a motor;
a mixing chamber removably mounted on the base;
an ice canister and auger assembly disposed substantially horizontally inside the mixing chamber, the ice canister and auger assembly including a cylindrical ice canister, an auger disposed around the ice canister, and a gearbox engaged with the auger and the ice canister; and
a cover for covering the mixing chamber,
wherein the base further includes a drive shaft driven by the motor, wherein the gearbox of the ice canister and auger assembly is engaged with the drive shaft to drive the auger to rotate in a first direction and to drive the ice canister to rotate in a second direction opposite the first direction, and
wherein the ice canister has a divider that divides an interior space of the ice canister into two or more compartments parallel to a rotation axis of the ice canister.

2. The device of claim 1, wherein the ice canister and auger assembly is removable from the mixing chamber, and wherein the ice canister and the auger are detachable from the gearbox.

3. The device of claim 1, further comprising a locking mechanism for locking the mixing chamber to the base.

4. The device of claim 1, wherein the cover has an opening and a lid for closing the opening.

5. The device of claim 1, wherein the ice canister is made of aluminum.

6. The device of claim 1, wherein the auger includes a plurality of blades located at its front end, the blades forming an angle of approximately 15 to 25 degrees with respect to a plane perpendicular to a rotation axis of the auger.

7. The device of claim 6, wherein the blades form an angle of approximately 20 degrees with respect to the plane perpendicular to the rotation axis of the auger.

8. The device of claim 1, wherein the mixing chamber has a front end wall and a dispenser located on the front end wall, the front end wall being substantially vertical with a pie-shaped portion adjacent the dispenser that forms a wedge angle of approximately 6 to 10 degrees with respect to the vertical direction.

9. The device of claim 8, wherein the pie-shaped portion forms a wedge angle of approximately 8 degrees with respect to the vertical direction.
